(19) United States
(12) Patent Application Publication
(10) Pub. No.: US 2008/0200573 A1
(43) Pub. Date: Aug. 21, 2008

(54) Flame Retarded Styrenic Foams and Foam Precursors

(75) Inventors: Kimberly A. Maxwell, Baton Rouge, LA (US); Saadat Hussain, Baton Rouge, LA (US); Dominique Fasbinder, Braives (BE); Danielle F. Goossens, Nodebais (BE); Govindarajulu Kumar, Baton Rouge, LA (US); Arthur G. Mack, Prairieville, LA (US); Paul F. Ranken, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 11/996,852

(22) PCT Filed: Aug. 1, 2006
(86) PCT No.: PCT/US06/29814

§ 371 Date: Jan. 25, 2008

Related U.S. Application Data
(60) Provisional application No. 60/706,646, filed on Aug. 8, 2005.

(51) Int. Cl. C08J 9/00

(52) U.S. Cl. 521/126; 521/117; 521/114; 521/128; 521/131; 521/124

(57) ABSTRACT

Styrenic polymer foams, especially expanded and/or extruded styrenic polymer foams, are flame retarded by use of one or more flame retardant additives. These additives are i) a diether of tetrabromobisphenol-S, which ether groups do not contain bromine and wherein at least one of the ether groups is an allyl group; ii) a diether of tetrabromobisphenol-S, wherein at least one of the ether groups contains bromine; iii) a substituted benzene having a total of 6 substituents on the ring and wherein at least 3 of the substituents are bromine atoms and at least two of the substituents are C1-4 alkyl groups; iv) tribromoneopentyl alcohol; v) a tris(dibromoalkyl) benzenetricarboxylate in which each dibromoalkyl group contains, independently, 3 to 8 carbon atoms; vi) a brominated polybutadiene which is partially hydrogenated and/or aryl-terminated; vii) at least one brominated allyl ether of a novolac; viii) a brominated poly(1,3-cycloalkadiene); ix) a brominated poly(4-vinylphenol allyl ether); x) a brominated N,TSP-phenylenebismaleimide; xi) a brominated N,N′-(4,4′-methylenediphenyl)bismaleimide; xii) a brominated N,N′-ethylenebis-maleimide; xiii) ethylenebis(dibromonorbornane-dicarboxrmide); xiv) tetrabromobisphenol-A; or xv) a combination of any two or more of i) through xiv).

### BACKGROUND

Styrenic polymer foams such as extruded polystyrene foams (XPS) and expandable polystyrene foams (EPS) are in widespread use. In many cases it is desired to decrease the flammability of such products by incorporating a flame retardant therewith. It is desirable therefore to provide flame retardants that can be used in the production of both types of products.

Flame retardant extruded styrenic polymers such as XPS are typically made by mixing the styrenic polymer, a flame retardant, and a blowing agent in an extruder, and extruding the resultant mixture through a die providing the desired dimensions of the product, such as boards with various thicknesses and one of several different widths. For use in this process it is important that the flame retardant have good thermal stability and low corrosivity toward metals with which the hot blend comes into contact in the process. Also it is desirable that the flame retardant mix well with the other components in the extruder.

Flame retardant expandable styrenic polymers such as EPS are typically made by suspension polymerization of a mixture of styrene monomer(s) and flame retardant in water to form beads of styrenic polymer. The small beads (e.g., averaging about 1 mm in diameter) so formed are then pre-expanded with steam and then molded again with steam to produce large foam blocks which can be several meters high, and 2-3 meters wide, that will be cut in the desired dimensions. For use in this process it is desirable for the flame retardant to have at least some solubility in the styrenic monomer(s), especially in styrene.

While some brominated flame retardants have been proposed or used in extruded styrenic polymers such as XPS and/or in expandable styrenic polymers such as EPS, typically high dosage levels of flame retardant have been required to achieve the desired effectiveness. The high cost of some of those flame retardants when coupled with the high dosage levels required for good effectiveness constitute a problem requiring an effective solution.

This invention provides new flame retardant expanded and extruded styrenic polymers and processes by which they can be prepared.

### BRIEF SUMMARY OF THIS INVENTION

This invention provides styrenic polymer foams and styrenic polymer foam precursors that are flame retarded by use of one or more bromine-containing flame retardant additives specified hereinafter.

Other embodiments of this invention are methods for producing such flame retarded styrenic polymer foam compositions and such flame retarded styrenic polymer foam precursor compositions.

The one or more bromine-containing flame retardant additives used in producing the compositions of this invention are as follows:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbomane-dicarboximide); or
xiv) tetrabromobisphenol-A; or
xv) a combination of any two or more of i) through xiv).

Of the above flame retardants, those of categories vii), viii), x), xi), and xii) are believed to be new compositions of matter. At least some of the flame retardants of category vi) are also believed to be new compositions of matter.

The above bromine-based flame retardants are characterized by suitably high bromine contents. In addition, they can be effectively used as flame retardants in either EPS, XPS, or both EPS and XPS type compositions, in that experience to date indicates that they should have good solubility in styrenic monomers such as styrene to facilitate use in forming EPS-type beads or granules, they should have adequate thermal stability for use in styrenic polymer foams, they should have desirable melting temperatures, and they should be effective at low dosage levels. Moreover, some if not all, of these flame retardants should be suitably cost-effective as flame retardants because of the low loading levels at which they can be effectively used. In particular, flame retardant additives of categories i)-vi) are suitable for use in both EPS and XPS type compositions. Flame retardant additives of category i) are more suitable for use in EPS type compositions, while flame retardant additives of categories vii)-xiii) are more suitable for use in XPS type compositions.

Pursuant to one embodiment of this invention, there is provided a flame retardant styrenic polymer foam composition which comprises a styrenic polymer and flame retardant amount of flame retardant resulting from inclusion in the foam recipe before or during formation of the foam:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbornane-dicarboximide); or
xiv) tetrabromobisphenol-A; or
xv) a combination of any two or more of i) through xiv).

In another embodiment of this invention, there is provided a flame retardant styrenic polymer foam composition which comprises a styrenic polymer and flame retardant amount of flame retardant resulting from inclusion of the flame retardant in the foam recipe before or during formation of the foam, wherein said styrenic polymer foam composition is either a) in the form of expandable styrenic polymer beads or granules or b) in the form of an extruded styrenic polymer foam; when said styrenic polymer foam composition is a), said flame retardant is
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or a combination of any two or more of i) through vii);
   and when said styrenic polymer foam composition is b), said flame retardant is
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbornane-dicarboximide); or
xiv) tetrabromobisphenol-A; or
a combination of any two or more of ii) through xiv).

In one embodiment of this invention the flame retardant used in forming the expanded styrenic polymer is
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or a combination of any two or more of i) through vii).
   In this embodiment, no other flame retardant is employed.

In another embodiment of this invention the sole flame retardant used in forming the expanded styrenic polymer is
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or a combination of any two or more of i) through vii),
   and at least one synergist, such as dicumyl, or at least one thermal stabilizer, such as dibutyl tin maleate or hydrocalcite is included in the expanded styrenic polymer. When employed, the amount of such synergist is typically in the range of about 0.1 to about 0.4 wt % based on the total weight of the polymer composition. The amount of such thermal stabilizer, when employed, is typically in the range of about 1 to about 5 wt % based on the total weight of the polymer composition. It will be noted that the expanded styrenic polymer compositions of this invention can be devoid of synergists employed in unfoamed or unexpanded styrenic polymers such as antimony oxide.

In one embodiment of this invention the flame retardant used in forming the extruded styrenic polymer is
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether), or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbornane-dicarboximide); or
xiv) tetrabromobisphenol-A; or
a combination of any two or more of ii) through xiv).
   In this embodiment, no other flame retardant is employed.

In another embodiment of this invention the sole flame retardant used in forming the extruded styrenic polymer is
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbornane-dicarboximide); or
xiv) tetrabromobisphenol-A; or
a combination of any two or more of ii) through xiv),
   and at least one synergist, such as dicumyl, or at least one thermal stabilizer, such as dibutyl tin maleate or hydrocalcite is included in the extruded styrenic polymer. When employed, the amount of such synergist is typically in the range of about 0.1 to about 0.4 wt % based on the total weight of the polymer composition. The amount of such thermal stabilizer, when employed, is typically in the range of about 1 to about 5 wt % based on the total weight of the polymer composition. It will be noted that the extruded styrenic polymer compositions of this invention can be devoid of synergists employed in unfoamed or unexpanded styrenic polymers such as antimony oxide.

It will be understood and appreciated that when a given flame retardant is included in the foam recipe before or during formation of the foam, (a) the composition of the given flame retardant in the resultant foam may not be changed, or (b) the composition of the given flame retardant may in part be changed or altered such that the resultant foam contains some of the given flame retardant along with one or more different substances derived from the given flame retardant, at least one of which different substances preferably is a flame retardant substance different from the given flame retardant, or (c) the composition of the given flame retardant may be entirely changed or altered such that the resultant foam contains in lieu of any of the given flame retardant one or more substances derived from the given flame retardant that are different from the given flame retardant, at least one of which different substances is a flame retardant substance. Thus, when the phrase “flame retardant resulting from inclusion in the foam recipe” (or a phrase of similar import) is used herein, the words “flame retardant” (although used in the singular) does not in any way restrict the number of flame retardant substances that may result from the inclusion in the foam recipe of one or more given flame retardants. Also, as used herein and unless expressly indicated to the contrary, the term “flame retardant” or “flame retardant amount” does not constitute a restriction on the number of flame retardant components that may be present or used in the foam recipe or resultant foam.

By the term “foam recipe” as used herein, is meant any combination of materials that can be expanded to form a foam. Thus, for example, a “foam recipe” can be:
1) a mixture formed from components comprised of at least styrenic polymer, at least one flame retardant of this invention, and at least one blowing agent, such mixture being extrudable to form an XPS-type of foam; or
2) a mixture formed from components comprised of at least one styrenic monomer and at least one flame retardant of this invention, which mixture is in water or other liquid medium in which suspension polymerization can be carried out to form beads or granules of styrenic polymer; or
3) beads or granules made by suspension polymerization of a mixture as in 2), which beads or granules can be pre-expanded, for example by steam to form larger beads; or
4) larger pre-expanded beads or granules formed by pre-expanding, for example, with steam, beads or granules made by suspension polymerization of a mixture as in 2), which larger pre-expanded beads can be molded, for example, with steam to produce large blocks of expanded styrenic polymer such as EPS-type foam. In other words, a “foam recipe” is any precursor mixture of a styrenic polymer foam of this invention.

The above and other embodiments and features of this invention will become still further apparent from the ensuing description.

### FURTHER DETAILED DESCRIPTION OF THE INVENTION

### Styrenic Polymers

The styrenic polymer foams which are flame retarded pursuant to this invention are foamed (expanded) polymers of one or more polymerizable alkenyl aromatic compounds. At least a major amount (by weight) of at least one alkenyl aromatic compound of the formula

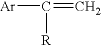

where Ar is an aromatic hydrocarbyl group and R is a hydrogen atom or a methyl group, is chemically combined to form a styrenic homopolymer or copolymer. Examples of such styrenic polymers are homopolymers of styrene, alpha-methylstyrene, o-methylstyrene, m-methylstyrene, p-methylstyrene, ar-ethylstyrene, ar-vinylstyrene, ar-chlorostyrene, ar-bromostyrene, ar-propylstyrene, ar-isopropylstyrene, 4-tert-butylstyrene, o-methyl-alpha-methylstyrene, m-methyl-alpha-methylstyrene, p-methyl-alpha-methylstyrene, ar-ethyl-alpha-methylstyrene, and copolymers of two or more of such alkenyl aromatic compounds with minor amounts (by weight) of other readily polymerizable olefinic compounds such as, for example, methyl methacrylate, acrylonitrile, maleic anhydride, citraconic anhydride, itaconic anhydride, acrylic acid, vinyl carbazole, and rubber reinforced (either natural or synthetic) styrenic polymers. Preferably at least 80 weight % of styrene is incorporated in the styrenic copolymers. Thus in each and every embodiment of this invention set forth anywhere in this disclosure, the styrenic polymer of the foam preferably comprises polystyrene or a styrenic copolymer in which at least 80 wt % of the polymer is formed from styrene.

The styrenic polymers can be a substantially thermoplastic linear polymer or a mildly cross-linked styrenic polymer. Among suitable procedures that can be used for producing mildly cross-linked styrenic polymers for use in foaming operations are those set forth, for example, in U.S. Pat. Nos. 4,448,933; 4,532,264; 4,604,426; 4,663,360 and 4,714,716.

Methods for producing styrenic foams including both XPS foams and EPS foams are well known and reported in the literature. Thus any suitable method can be employed as long as the resultant foam is flame retarded by use of a flame retardant amount of one or more flame retardants pursuant to this invention. As a guide for dosage levels for use in foamed styrenic polymers, it is desirable to blend small amounts of the flame retardant in unfoamed crystal styrenic polymer and determine the LOI (Limited Oxygen Index) of molded test specimens made from the unfoamed blend. If such test specimens give an LOI that is at least one unit higher than a molded specimen of the same neat styrenic polymer, the dosage level should be suitable when used in the same foamed or foamable styrenic polymer. Typically the amount of flame retardant used in the styrenic foams of this invention including both XPS foams and EPS foams is in the range of about 0.4 to about 6 wt %, and preferably in the range of about 0.7 to about 5 wt % based on the total weight of the foam composition. More preferably, the amount of flame retardant used in the styrenic foams is in the range of about 1 to about 4 wt % based on the total weight of the foam composition.

### Extruded Styrenic Foams

Flame retarded styrenic polymer foams can be prepared conveniently and expeditiously by use of known procedures. For example one useful general procedure involves heat plastifying a thermoplastic styrenic polymer composition of this invention in an extruder. From the extruder the heat plastified resin is passed into a mixer, such as a rotary mixer having a studded rotor encased within a housing which preferably has a studded internal surface that intermeshes with the studs on the rotor. The heat-plastified resin and a volatile foaming or blowing agent are fed into the inlet end of the mixer and discharged from the outlet end, the flow being in a generally axial direction. From the mixer, the gel is passed through coolers and from the coolers to a die which extrudes a generally rectangular board. Such a procedure is described for example in U.S. Pat. No. 5,011,866. Other procedures include use of systems in which the foam is extruded and foamed under sub-atmospheric, atmospheric and super-atmospheric pressure conditions. As indicated in U.S. Pat. No. 5,011,866, one useful sub-atmospheric (vacuum) extrusion process is described in U.S. Pat. No. 3,704,083. This process is indicated to be of advantage in that the type of vacuum system therein described does not require a low-permeability/high permeability blowing agent mixture, due to the influence of the vacuum on the foaming process. Other disclosures of suitable foaming technology appear, for example, in U.S. Pat. Nos. 2,450,436; 2,669,751; 2,740,157; 2,769,804; 3,072,584; and 3,215,647.

### Expandable Styrenic Beads or Granules

The styrenic polymer compositions of this invention can be used in the production of expandable beads or granules having enhanced flame resistance. In general, these materials may be produced by use of equipment, process techniques and process conditions previously developed for this purpose, since the flame retardant compositions of this invention do not materially affect adversely the processing characteristics and overall properties of the styrenic polymer employed. Also, known and established techniques for expanding the expandable beads or granules, and for molding or forming the further expanded beads or granules into desired products are deemed generally applicable to the expandable beads or granules formed from the styrenic polymer compositions of this invention. Suitable technology for producing expandable beads or granules is disclosed, for example, in U.S. Pat. Nos. 2,681,321; 2,744,291; 2,779,062; 2,787,809; 2,950,261; 3,013,894; 3,086,885; 3,501,426; 3,663,466; 3,673,126; 3,793,242; 3,973,884; 4,459,373; 4,563,481; 4,990,539; 5,100,923; and 5,124,365. Procedures for converting expandable beads of styrenic polymers to foamed shapes is described, for example, in U.S. Pat. Nos. 3,674,387; 3,736,082; and 3,767,744.

### Flame Retardants

The flame retardants utilized in the practice of this invention are of the following categories:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis(dibromonorbomane-dicarboximide); or
xiv) tetrabromobisphenol-A; or
xv) a combination of any two or more of i) through xiv).

Flame retardant categories i) and ii) are at least one diether of tetrabromobisphenol-S. These compounds can be represented by the formula

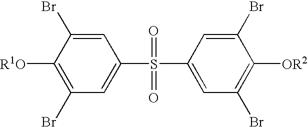

where in category i), R¹and R² are the same or different and are alkyl, alkenyl, aryl, chloroalkyl, dichloroalkyl, each containing up to 10 carbon atoms, and preferably up to 6 carbon atoms; at least one of R¹ and R² is an allyl group. The allyl propyl diether of tetrabromobisphenol-S serves as a non-limiting example of an asymmetrical ether (R¹ and R² differ from each other) in this flame retardant category. A particularly preferred diether of tetrabromobisphenol-S in this category is the bis(allyl ether) of tetrabromobisphenol-S (a.k.a. the bis(allyl ether) of 3,5,3′,5′-tetrabromo-4,4′-dihydroxydiphenyl sulfone).

In category ii), R¹ and R² are the same or different and at least one of R¹ and R² is bromoalkyl, dibromoalkyl, or tribromoalkyl, each containing up to 10 carbon atoms, and preferably up to 6 carbon atoms. The 2,3-dibromopropyl 2,3-dichloropropyl diether of tetrabromobisphenol-S serves as a non-limiting example of asymmetrical ethers (R¹ and R² differ from each other). Preferred diethers of tetrabromobisphenol-S are symmetrical ethers (i.e., where R¹ and R² are same as each other). Some non-limiting examples of such symmetrical compounds include the bis(2,3-dibromopropyl ether) of tetrabromobisphenol-S (a.k.a. the bis(2,3-dibromopropyl ether) of 3,5,3′,5′-tetrabromo-4,4′-dihydroxydiphenyl sulfone), the bis(2-bromopropyl ether) of tetrabromobisphenol-S, the bis(3,4-dibromobutyl ether) of tetrabromobisphenol-S, and other bromine-containing diethers of tetrabromobisphenol-S of the above formula. Especially preferred category ii) flame retardants include the bis(2,3-dibromopropyl ether) of tetrabromobisphenol-S.

See U.S. Pat. Nos. 4,777,297 and 4,006,118 for methods that can be used for producing flame retardants of categories i) and ii).

Flame retardant category iii) is at least one substituted benzene having a total of 6 substituents on the ring wherein at least 3 of the substituents are bromine atoms and at least two substituents are C₁₋₄ alkyl groups. The ring positions occupied by these 6 ring substituents can vary in any manner. Non-limiting examples of the compounds of this category are 1,2,3-tribromo-4,5,6-trimethylbenzene; 1,2,4-tribromo-3,5,6-trimethylbenzene; 1,3,5-tribromo-2,4,6-trimethylbenzene; 1,2,3,5-tetrabromo-4,6-dimethylbenzene; 1,2,4,5-tetrabromo-3,6-dimethylbenzene; 1,2,3,4-tetrabromo-5,6-dimethylbenzene; 1,2,3-tribromo-4,5,6-triethylbenzene; 1,2,4-tribromo-3,5,6-triethylbenzene; 1,3,5-tribromo-2,4,6-triethylbenzene; 1,2,3,5-tetrabromo-4,6-diethylbenzene; 1,2,4,5-tetrabromo-3,6-diethylbenzene; 1,2,3,4-tetrabromo-5,6-diethylbenzene; 1,2,3-tribromo-5-ethyl-4,6-dimethylbenzene; 1,3,5-tribromo-2,4-diethyl-6-methylbenzene; 1,3,5-tribromo-6-ethyl-2,4-dimethylbenzene; 1,2,4,5-tetrabromo-3-ethyl-6-methylbenzene; 1,3,5-tribromo-2,6-dimethyl-4-n-propylbenzene; 1,2,4,5-tetrabromo-3,6-di-tert-butylbenzene; and the like, including other positional isomers. These compounds can be prepared by use of Lewis acid-catalyzed bromination of the appropriate alkyl-substituted benzene (or mixture of alkyl-substituted benzenes), e.g., one or a mixture of more than one xylene isomer, one or a mixture of more than one trimethylbenzene isomer, 1,3-diisopropylbenzene, and 1-methyl-2-n-butylbenzene. Ferric bromide is a suitable Lewis acid catalyst for such ring brominations.

Flame retardant category iv) is tribromoneopentyl alcohol.

Flame retardant category v) is at least one tris(dibromoalkyl) benzenetricarboxylate in which each dibromoalkyl group contains, independently, 3 to 8 carbon atoms. The three dibromoalkyl carboxylic ester groups can be in the 1,2,3-positions, the 1,2,4-positions or the 1,3,5-positions. When the ester is the 1,2,3-isomer, it may also be named as an ester of hemimellitic acid; when the ester is the 1,2,4-isomer, it may also be named as an ester of trimellitic acid; and when the ester is the 1,3,5-isomer, it may also be named as an ester of trimesic acid. The dibromoalkyl groups can differ among themselves, and in such case each of the dibromoalkyl groups independently contains in the range of 3 to about 8 carbon atoms, and preferably in the range of 3 to about 5 carbon atoms. Preferably each of the three dibromoalkyl groups has the same carbon atom content in the range of 3 to about 8 carbon atoms, more preferably in the range of 3 to about 5 carbon atoms. Irrespective of whether the dibromoalkyl groups are all of the same carbon atom content or two or all three of them differ in the number of carbon atoms therein, it is preferred that the one of the two bromine atoms be on the outermost terminal carbon atom with the other bromine atom being on the adjacent carbon atom. Tris(2,3-dibromopropyl) 1,2,3-benzenetricarboxylate, tris(2,3-dibromopropyl) 1,2,4-benzenetricarboxylate, Tris(2,3-dibromopropyl) 1,3,5-benzenetricarboxylate, tris(3,4-dibromobutyl) 1,2,3-benzenetricarboxylate, tris(4,5-dibromopentyl) 1,2,4-benzenetricarboxylate, tris(5,6-dibromohexyl) 1,3,5-benzenetricarboxylate, tris(6,7-dibromoheptyl) 1,2,4-benzenetricarboxylate, and tris(7,8-dibromooctyl) 1,3,5-benzenetricarboxylate serve as non-limiting examples of this category of flame retardants. Tris(2,3-dibromopropyl) 1,2,4-benzenetricarboxylate and tris(2,3-dibromopropyl) 1,3,5-benzenetricarboxylate are preferred members of this category of flame retardants.

One method for preparing the esters of flame retardant category v) is by bromination of a tris(alkenyl) ester of a benzenetricarboxylic acid under conventional bromination conditions used for adding bromine to an olefinic compound using bromine as the brominating agent. See in this connection U.S. Pat. No.3,236,659, which discloses this and other methods for making flame retardants of category v).

Flame retardant category vi) is at least one brominated polybutadiene which is partially hydrogenated, aryl-terminated, or both partially hydrogenated and aryl-terminated. These are usually made by bromination of at least one oligomeric or polymeric polybutadiene that is partially hydrogenated and/or aryl-terminated. As used herein, the term “polybutadiene” means a polymer made from 1,3-butadiene and in which at least about 50 mole percent of the unsaturation in the polymer is 1,2-(vinyl) linkages. It is preferred that the polybutadiene has at least about 70 mole % of the unsaturation as 1,2-linkages; more preferably, the polybutadiene has at least about 75 mole % of the unsaturation as 1,2-linkages. Especially preferred is a polybutadiene that has in the range of about 75 mole % to about 95 mole % of the unsaturation as 1,2-linkages. The polybutadiene can be atactic, isotactic, or syndiotactic. A brominated partially hydrogenated polybutadiene either with or without aryl termination is a preferred brominated polybutadiene. Terminal aryl groups, when present, typically have up to about 10 carbon atoms each, and may be ring-brominated; when alkyl substituents are present on the aryl groups, these alkyl groups may be brominated. Both ring-bromination and brominated alkyl substituents may be present in the terminal aryl groups. Preferably, the terminal aryl groups are phenyl or alkyl-substituted phenyl groups having up to about 10 carbon atoms each. More preferred terminal groups are unsubstituted phenyl groups. When the polybutadiene is partially hydrogenated, the initial polybutadiene oligomer or polymer (or mixture thereof) is typically hydrogenated such that about 10 to about 75 mole percent of the original unsaturation becomes saturated by hydrogen atoms. In other words, the unsaturation in the polybutadiene normally remains at a level of at least about 25 mole percent. Preferably, about 10 to about 60 mole percent of the original unsaturation is saturated by hydrogen. Preferred brominated polybutadienes in the practice of this invention have at least about 75 mole % 1,2-linkages. Another preferred brominated polybutadiene in this invention is both aryl-terminated and partially hydrogenated, especially where the terminal aryl groups are unsubstituted phenyl groups. Brominated polybutadiene having both aryl-termination and partial hydrogenation is often referred to as brominated aryl-terminated partially hydrogenated polybutadiene. Without wishing to be bound by theory, it is believed that partial hydrogenation of the polybutadiene improves the thermal stability and/or solubility of the flame retardants of this category. Brominated partially hydrogenated polybutadienes, brominated aryl-terminated polybutadienes, and brominated aryl-terminated partially hydrogenated polybutadienes are believed to be new compositions of matter.

One method for preparing flame retardants of category vi) is by brominating a suitable polybutadiene. When the polybutadiene is partially hydrogenated, suitable polybutadiene polymers or oligomers normally and preferably have a number average molecular weight in the range of about 2,000 to about 200,000. More preferably, the number average molecular weight of the partially hydrogenated polybutadiene is in the range of about 2,000 to about 20,000. In the absence of partial hydrogenation, suitable polybutadiene polymers or oligomers normally and preferably have a number average molecular weight in the range of about 1,000 to about 20,000; polybutadiene polymers with number average molecular weights up to about 50,000 can be used, if desired. More preferably, the number average molecular weight of a polybutadiene without partial hydrogenation is in the range of about 1,000 to about 10,000. The bromination of the polybutadiene is conducted with at least enough bromine or other brominating agent to theoretically saturate all residual aliphatic unsaturation in the oligomer(s) or polymer(s). In other words, there is, desirably, essentially no aliphatic unsaturation left in the final brominated product. In a typical preparation, the polybutadiene, a solvent which is typically a halogenated hydrocarbon, and a polar protic solvent (these solvents are at least a portion of the liquid medium) are placed in a reaction zone, and bromine is fed to the mixture in the reaction zone. The bromine may be fed in any of several ways that keep it dilute in the reaction zone. Such methods are well known in the art and include use of turbulent flow mixers, subsurface feeding of the bromine, and dissolution of the bromine in a solvent prior to its introduction into the reaction zone. During the feeding of the bromine, the mixture in the reaction zone is preferably kept at a temperature in the range of about −10° C. to about 60° C. Either before or after the bromine feed has been initiated, some aqueous HBr is preferably added to the reaction mixture in the reaction zone, usually in the range of about 1 to about 5 grams of HBr per 50 grams of polymer, preferably about 2 to about 4 grams of HBr per 50 grams of polymer. Suitable solvents include dichloromethane, dibromomethane, bromochloromethane, trichloromethane, 1,2-dichloroethane, 1,2-dibromoethane, 1-bromo-2-chloroethane, and the like, as well as mixtures of any two or more of the foregoing. Dichloromethane and bromochloromethane are preferred solvents in this bromination; bromochloromethane is more preferred. The presence of HBr, while not essential, appears to assist in making the reaction go to completion. Without wishing to be bound by theory, the presence of a polar protic solvent, such as water and/or an alkanol, is thought to minimize radical bromine addition. Examples of suitable polar protic solvents include, but are not limited to, water, methanol, ethanol, 1-propanol, 2-propanol, 1-butanol, 1-methyl-1-propanol, 2-methyl-1-propanol, and tert-butanol, and the like, as well as mixtures of two or more of the foregoing. A combination of water and ethanol is particularly preferred as the polar protic solvent.

Flame retardant category vii) is at least one brominated allyl ether of a novolac. Herein, as is customary in the art, “novolac” refers to the acid-catalyzed product of a reaction between phenol and formaldehyde. Thus, the brominated allyl ether of a novolac is normally a brominated allyl ether of a phenol-formaldehyde novolac. The bromine content of the brominated allyl ethers of novolac is typically at least about 49 wt %, and preferably the bromine content is at least about 51 wt %. More preferred is a bromine content of at least about 53 wt %. Brominated allyl ethers of novolacs are believed to be new compositions of matter.

One method for preparing flame retardants of category vii) is by brominating an allyl ether of a novolac under conventional bromination conditions used for adding bromine to an olefinic compound using bromine as the brominating agent. An allyl ether of a novolac can be made by reacting an allylation agent with the novolac in a procedure analogous to that disclosed in U.S. Pat. No. 4,424,310. For preparing their brominated ally ethers, the novolac generally has a weight average molecular weight of up to about 10,000. Preferably, the weight average molecular weight of the novolac is in the range of about 1,000 to about 5,000, and more preferably is in the range of about 1,100 to about 3,000, when preparing brominated allyl ethers of novolacs.

Flame retardant category viii) is at least one brominated poly(1,3-cycloalkadiene). A brominated poly(1,3-cycloalkadiene) is usually made by bromination of at least one oligomeric or polymeric poly(1,3-cycloalkadiene) having a number average molecular weight in the range of about 1000 to about 10,000, and preferably in the range of about 1500 to about 5000. The poly(1,3-cycloalkadiene) may be aryl-terminated, partially hydrogenated, or both aryl-terminated and partially hydrogenated. A brominated partially hydrogenated poly(1,3-cycloalkadiene) either with or without aryl termination is a preferred brominated polybutadiene. Terminal aryl groups, when present, typically have up to about 10 carbon atoms each, and are preferably phenyl or alkyl-substituted phenyl groups having up to about 10 carbon atoms each, and may be ring-brominated; when alkyl substituents are present on the aryl groups, these alkyl groups may be brominated. Both ring-bromination and brominated alkyl substituents may be present in the terminal aryl groups. Preferably, the terminal aryl groups are phenyl or alkyl-substituted phenyl groups having up to about 10 carbon atoms each. More preferred terminal groups are unsubstituted phenyl groups. When the poly(1,3-cycloalkadiene) is partially hydrogenated, the initial 1,3-cycloalkadiene oligomer or polymer (or mixture thereof) is typically hydrogenated such that about 10 to about 55 to 65 mole percent of the original unsaturation becomes saturated by hydrogen atoms. As the ring size of the poly(1,3-cycloalkadiene) increases, a greater amount of unsaturation is desired; more specifically, for poly(1,3-cyclohexadiene) the upper limit of saturation by hydrogen is about 65 mole percent, for poly(1,3-cycloheptadiene) the upper limit of saturation by hydrogen is about 60 mole percent, and for poly(1,3-cyclooctadiene) the upper limit of saturation by hydrogen is about 55 mole percent. In other words, the unsaturation in the poly(1,3-cycloalkadiene) normally remains at a level of at least about 35 to 45 mole percent, with the unsaturation preferably being higher for larger 1,3-cycloalkadiene rings. Preferably, about 10 to about 40 mole percent of the original unsaturation is saturated by hydrogen. Various poly(1,3-cycloalkadiene)s can be brominated and used as flame retardants according to this invention, including poly(1,3-cyclopentadiene), poly(1,3-cyclohexadiene), poly(1,3-cycloheptadiene), poly(1,3-cyclooctadiene), and the like, as well as aryl-terminated and/or partially hydrogenated analogs thereof. Brominated poly(1,3-cyclohexadiene) is a preferred brominated poly(1,3-cycloalkadiene) in the practice of this invention. A more preferred brominated poly(1,3-cycloalkadiene) in this invention is aryl-terminated, especially where the terminal aryl groups are unsubstituted phenyl groups. A brominated poly(1,3-cycloalkadiene) having aryl-termination is often referred to as a brominated aryl-terminated poly(1,3-cycloalkadiene). Brominated poly(1,3-cycloalkadiene)s, especially brominated aryl-terminated poly(1,3-cycloalkadiene)s, are believed to be new compositions of matter.

One method for preparing flame retardants of category viii) is by brominating a poly(1,3-cycloalkadiene). The bromination is conducted with at least enough bromine or other brominating agent to theoretically saturate all residual aliphatic unsaturation in the oligomer(s) or polymer(s). In other words, there is essentially no aliphatic unsaturation left in the final brominated product. The preparation of brominated poly(1,3-cycloalkadiene)s from a poly(1,3-cycloalkadiene) is similar to the preparation of brominated polybutadienes, as detailed above.

Flame retardant category ix) is at least one brominated poly(4-vinylphenol allyl ether), where “at least one” refers to different amounts of bromine in the molecule. As is known in the art, these can be made by reacting brominated poly(4-vinylphenol) with an allylation agent; see in this connection U.S. Pat. No. 4,424,310. The brominated poly(4-vinylphenol allyl ether) generally has a number average molecular weight in the range of about 3000 to about 20,000, and preferably in the range of about 5000 to about 10,000. The bromine content of the brominated poly(4-vinylphenol allyl ether) oligomer or polymer is typically at least about 40 wt %, and preferably the bromine content is at least about 45 wt %. More preferred is a bromine content of at least about 48 wt %.

Flame retardant category x) is at least one brominated N,N′-phenylenebismaleimide, where the “at least one” refers to different amounts of bromine in the molecule. The brominated N,N′-phenylenebismaleimide can be the 1,3- or the 1,4-phenylene isomer; the 1,3-phenylene isomer is preferred. There are preferably about three to about four bromine atoms in the brominated N,N′-phenylenebismaleimide molecule. More preferably, there are about four bromine atoms in the molecule. Thus a particularly preferred brominated N,N′-phenylenebismaleimide is tetrabromo-N,N′-1,3-phenylenebismaleimide.

One method for preparing flame retardants of category x) is by brominating a N,N′-phenylenebismaleimide. The bromination of a N,N′-phenylenebismaleimide is conducted with at least enough bromine or other brominating agent to place a bromine atom on each of the four available imido ring positions. In a typical preparation, a N,N′-phenylenebismaleimide, a solvent, typically a halogenated hydrocarbon, are placed in a reaction zone, and bromine is fed to the mixture in the reaction zone. During the feeding of the bromine, the mixture in the reaction zone is preferably kept at a temperature in the range of about 40° C. to about 60° C. Suitable solvents include dichloromethane, dibromomethane, bromochloromethane, trichloromethane, 1,2-dichloroethane, 1,2-dibromoethane, 1-bromo-2-chloroethane, and the like, as well as mixtures of any two or more of the foregoing. Dichloromethane is a preferred solvent in this bromination. The conditions for the bromination of N,N′-phenylenebismaleimides have not been optimized.

Flame retardant category xi) is at least one brominated N,N′-(4,4′-methylenediphenyl)-bismaleimide, where the “at least one” refers to different amounts of bromine in the molecule. Preferably, there are about three to about four bromine atoms in a molecule of brominated N,N-phenylenebismaleimide. More preferred is a brominated N,N′-(4,4′-methylenediphenyl)bismaleimide molecule having about four bromine atoms. An especially preferred brominated N,N′-(4,4′-methylenediphenyl)bismaleimide is tetrabromo-N,N′-(4,4′-methylenediphenyl)bismaleimide.

One method for preparing flame retardants of category xi) is by brominating N,N′-(4,4′-methylenediphenyl)-bismaleimide. The bromination is conducted with at least enough bromine or other brominating agent to place a bromine atom on each of the four available imido ring positions. The preparation of a brominated N,N′-(4,4′-methylenediphenyl)-bismaleimide is similar to the preparation of a brominated N,N′-phenylenebismaleimide as detailed above, except that during the feeding of the bromine, the mixture in the reaction zone is preferably kept at a temperature in the range of about 25° C. to about 45° C.

Flame retardant category xii) is at least one brominated N,N′-ethylenebismaleimide, where the “at least one” refers to different amounts of bromine in the molecule. There are preferably about three to about four bromine atoms in the brominated N,N′-ethylenebismaleimide molecule. Preferably, there are about four bromine atoms in the molecule. A particularly preferred brominated N,N′-ethylenebismaleimide is tetrabromo-N,N′-1,3-ethylenebismaleimide.

One method for preparing flame retardants of category xii) is by brominating N,N′-ethylenebismaleimide. The bromination is conducted with at least enough bromine or other brominating agent to place a bromine atom on each of the four available imido ring positions. The preparation of a brominated N,N′-ethylenebismaleimide is similar to the preparation of a brominated N,N′-phenylenebismaleimide as detailed above, except that during the feeding of the bromine, the mixture in the reaction zone is preferably kept at a temperature in the range of about 25° C. to about 45° C.

Flame retardant category xiii) is ethylenebis(dibromonorbornane-dicarboximide).

Flame retardant category xiv) is tetrabromobisphenol-A.

### Foaming Agents

Any of a wide variety of known foaming agents or blowing agents can be used in producing the expanded or foamed flame resistant polymers of this invention. U.S. Pat. No. 3,960,792 gives a listing of some suitable materials. Generally speaking, volatile carbon-containing chemical substances are the most widely for this purpose. They include, for example, such materials as aliphatic hydrocarbons including ethane, ethylene, propane, propylene, butane, butylene, isobutane, pentane, neopentane, isopentane, hexane, heptane and mixtures thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane; and mixtures of such materials. One preferred fluorine-containing blowing agent is 1,1-difluoroethane also known as HFC-152a (FORMACEL Z-2, E.I. duPont de Nemours and Co.) because of its reported desirable ecological properties. Water-containing vegetable matter such as finely-divided corn cob can also be used as blowing agents. As described in U.S. Pat. No. 4,559,367, such vegetable matter can also serve as fillers. Use of carbon dioxide as a foaming agent, or at least a component of the blowing agent, is particularly preferred because of its innocuous nature vis-a-vis the environment and its low cost. Methods of using carbon dioxide as a blowing agent are described, for example, in U.S. Pat. No. 5,006,566 wherein the blowing agent is 80 to 100% by weight of carbon dioxide and from 0 to 20% by weight of one or more halohydrocarbons or hydrocarbons that are gaseous at room temperature, in U.S. Pat. Nos. 5,189,071 and 5,189,072 wherein a preferred blowing agent is carbon dioxide and 1-chloro-1,1-difluoroethane in weight ratios of 5/95 to 50/50, and in U.S. Pat. No. 5,380,767 wherein preferred blowing agents comprise combinations of water and carbon dioxide. Other preferred blowing agents and blowing agent mixtures include nitrogen or argon, with or without carbon dioxide. If desired, such blowing agents or blowing agent mixtures can be mixed with alcohols, hydrocarbons or ethers of suitable volatility. See for example, U.S. Pat. No. 6,420,442.

### Other Components

Such ingredients as extrusion aids (e.g., barium stearate or calcium stearate), peroxide or C—C synergists, acid scavengers (e.g., magnesium oxide or tetrasodium pyrophosphate), dyes, pigments, fillers, stabilizers, antioxidants, antistatic agents, reinforcing agents, and the like can be included in the foam compositions of this invention. If desired, nucleating agents (e.g., talc, calcium silicate, or indigo) to control cell size can be included in the styrenic polymer compositions used in producing the flame retardant expanded or foamed styrenic polymers of this invention. Each of the particular ancillary materials selected for use in the foam compositions of this invention are used in conventional amounts, and should be selected such that they do not materially affect adversely the properties of the finished polymer foam composition for its intended utility.

As described above, in some preferred embodiments of this invention, no other flame retardant is employed. In other preferred embodiments of this invention, at least one synergist, such as dicumyl, or at least one thermal stabilizer, such as dibutyl tin maleate or hydrocalcite is included in the styrenic polymer foam composition. When employed, the amount of such synergist is typically in the range of about 0.1 to about 0.4 wt % based on the total weight of the polymer composition. The amount of such thermal stabilizer, when employed, is typically in the range of about 1 to about 5 wt % based on the total weight of the polymer composition. It will be noted that both the expanded styrenic polymer compositions of this invention and the extruded styrenic polymer compositions of this invention can be devoid of synergists employed in unfoamed or unexpanded styrenic polymers such as antimony oxide.

The following Examples are presented for purposes of illustration and are not intended to impose limitations on the scope of this invention.

### EXAMPLES 1-23 AND COMPARATIVE EXAMPLE CA

To illustrate flame retardant effectiveness, polystyrene compositions were prepared and subjected to ASTM Standard Test Method D 2863-87 commonly referred to as the limiting oxygen index (LOI) test. In this test, the higher the LOI value, the more flame resistant the composition. The test specimens were prepared using Styron® 678E polystyrene from The Dow Chemical Company. This material is a general purpose non-flame retarded grade of unreinforced, crystal polystyrene (GPPS). It has a melt flow index at 200° C, and 5 kg pressure of 10 grams per 10 minutes, and an LOI of 18.0. Table 1 identifies the flame retardants used in Examples 1-23 both as to chemical identity and the category of this invention in which such flame retardant falls. Additionally, Table 1 sets forth the loadings, bromine contents, and LOI results of Examples 1-23. Each flame retardant was used without any other flame retardant or flame retardant assistant or synergist. In Comparative Example CA the test specimens were prepared from the same polystyrene without any flame retardant or additive mixed therewith.

To form the test specimens of Examples 1-23, the following general procedure was used: Using a Haake rheomix 600 machine, a known amount, e.g., 45 g, of GPPS was placed in the mixing chamber heated at 150° C. and mixed 100 rpm for approximately 2 minutes. Then a measured quantity of the flame retardant to be evaluated was added to the molten GPPS and mixing was continued for about 3 more minutes. The rotors were then stopped and the mixing chamber was opened to collect the resultant compounded blend which was then cooled down to room temperature. For each flame retardant, three batches were produced in this manner to have enough material for compression molding test plaques.

Before compression molding, the respective batches were first ground and then passed through a 4 mm sieve. Then approximately 115 g of the ground material was poured into a 190×190 mm insert at room temperature. The insert containing the ground material was put between heated platens at 180° C for 1 minute at about 20 kN. Then a pressure of 200 kN was applied for about 7 more minutes. The insert was then cooled between 2 other platens at 20° C for about 8 minutes with a pressure of 200 kN. A plaque of 190×190×2.75(+/−0.15) mm was then removed from the mold. Two plaques of 95×95 mm and 17 bars of 10×95 mm were cut out of the larger plaque. The bars were used for LOI evaluations.

TABLE 1

| | | | | Bromine | |
|---|---|---|---|---|---|
| Ex | Flame retardant | Category | Loading | content | LOI |
| 1 | Bis(allyl ether) of tetrabromobisphenol-S | i) | 1.52 wt % | 0.75 wt % | 25.1 |
| 2 | Bis(allylether) of tetrabromobisphenol-S | i) | 4.55 wt % | 2.25 wt % | 26.7 |
| 3 | Bis(2,3-dibromopropyl ether) of | ii) | 1.13 wt % | 0.75 wt % | 21.1 |
| | tetrabromobisphenol-S | | | | |
| 4 | Bis(2,3-dibromopropyl ether) of | ii) | 3.40 wt % | 2.25 wt % | 22.1 |
| | tetrabromobisphenol-S | | | | |
| 5 | Tetrabromoxylenes | iii) | 0.99 wt % | 0.75 wt % | 18.8 |
| 6 | Tetrabromoxylenes | iii) | 2.97 wt % | 2.25 wt % | 22.7 |
| 7 | Tribromoneopentyl alcohol | iv) | 1.02 wt % | 0.75 wt % | 21.9 |
| 8 | Tribromoneopentyl alcohol | iv) | 3.05 wt % | 2.25 wt % | 23.8 |
| 9 | Tris(dibrompropyl) 1,2,4- | v) | 1.27 wt % | 0.75 wt % | 21.5 |
| | benzenetricarboxylate | | | | |
| 10 | Tris(dibrompropyl) 1,2,4- | v) | 3.80 wt % | 2.25 wt % | 23.4 |
| | benzenetricarboxylate | | | | |
| 11 | Tris(dibrompropyl) 1,3,5- | v) | 3.80 wt % | 2.25 wt % | 22.9 |
| | benzenetricarboxylate | | | | |
| 12 | Brominated phenyl-terminated partially | vi) | 0.82 wt % | 0.525 wt % | 25.7 |
| | hydrogenated polybutadiene | | | | |
| 13 | Brominated allyl ether of phenol- | vii) | 4.40 wt % | 2.25 wy % | 22.5 |
| | formaldehyde novolac | | | | |
| 14 | Brominated poly(4-vinylphenol allyl | ix) | 1.52 wt % | 0.75 wt % | 23.1 |
| | ether) | | | | |
| 15 | Brominated poly(4-vinylphenol allyl | ix) | 4.56 wt % | 2.25 wt % | 21.1 |
| | ether) | | | | |
| 16 | Brominated N,N′-1,3- | x) | 1.38 wt % | 0.75 wt % | 22.6 |
| | phenylenebismaleimide | | | | |
| 17 | Brominated N,N′-1,3- | x) | 4.14 wt % | 2.25 wt % | 25.0 |
| | phenylenebismaleimide | | | | |
| 18 | Brominated N,N′-(4,4′- | xi) | 1.59 wt % | 0.75 wt % | 22.2 |
| | methylenediphenyl)bismaleimide | | | | |
| 19 | Brominated N,N′-(4,4′- | xi) | 4.77 wt % | 2.25 wt % | 24.0 |
| | methylenediphenyl)bismaleimide | | | | |
| 20 | Brominated N,N′-ethylenebismaleimide | xii) | 1.26 wt % | 0.75 wt % | 24.2 |
| 21 | Brominated N,N′-ethylenebismaleimide | xii) | 3.79 wt % | 2.25 wt % | 24.8 |
| 22 | Ethylenebis(dibromonorbornane- | xiii) | 1.58 wt % | 0.75 wt % | 22.8 |
| | dicarboximide) | | | | |
| 23 | Ethylenebis(dibromonorbornane- | xiii) | 4.73 wt % | 2.25 wt % | 25.1 |
| | dicarboximide) | | | | |
| CA | None | — | — | — | 18.0 |

### EXAMPLES 24-27

The same procedures as in Examples 1-23 were carried out using flame retardants of this invention in combination with another component useful in the preparation of flame retarded styrenic polymer compositions. The polystyrene used was the same kind as used in Examples 1-23 and CA. The other components used were dicumyl (flame retardant synergist), dibutyl tin maleate (thermal stabilizer), and hydrotalcite (thermal stabilizer). The hydrotalcite used was DHT-4A (Kyowa Chemical Company). Dicumyl is a common name for 2,3-dimethyl-2,3-diphenylbutane. The makeup of the test compositions and the test results are summarized in Table 2.

TABLE 2

| Ex. | Flame retardant | Cat. | Additive | Loading | Bromine content | LOI |
|---|---|---|---|---|---|---|
| 24 | Tetrabromoxylenes | iii) | dicumyl, 0.3% | 2.97 wt % | 2.25 wt % | 24.8 |
| 25 | Brominated phenyl-terminated | vi) | dibutyl tin maleate, 2% | 3.59 wt % | 2.25 wt % | 24.5 |
| | partially hydrogenated | | | | | |
| | polybutadiene | | | | | |
| 26 | Brominated phenyl-terminated | viii) | dibutyl tin maleate, 2% | 4.25 wt % | 2.25 wt % | 22.3 |
| | poly(1,3-cyclohexadiene) | | | | | |
| 27 | Tetrabromobisphenol-A | xiv) | dicumyl, 0.3 wt % | 3.35 wt % | 2.25 wt % | 25.4 |

### EXAMPLES 28-33 AND COMPARATIVE EXAMPLE CB

Expandable polystyrene beads (EPS) were prepared with and without addition of a flame retardant of this invention. In the procedure for the flame retardant EPS beads, 0.28 g of polyvinyl alcohol (PVA) was dissolved in 200 g of deionized water and poured into a 1-liter glass vessel. Separately, a solution was formed from 0.64g of dibenzoyl peroxide (75% in water), 0.22 g of dicumyl peroxide, and 1.45 g of a flame retardant of this invention in 200 g of styrene. This latter solution was poured into the vessel containing the PVA solution. The resultant liquid was charged to a polymerization reactor and mixed with an impeller-type stirrer set at 100 rpm in the presence of a baffle to generate shear in the reactor. The mixture was then subjected to the following heating profile:

From 20 to 90° C. in 45 minutes and held at 90° C. for 4.25 hours (first stage operation);

From 90 to 130° C. in 1 hour and held at 130° C. for 2 hours (second stage operation); and

From 130 to 20° C. in 1 hour.

At the end of the first stage the reactor was pressurized with nitrogen (2 bars). Once cooled down, the reactor was emptied and the mixture was filtered. The flame retardant beads formed in the process were dried at 60° C. overnight and then sieved to determine bead size distribution. Comparative Example CB was conducted in the same manner except that no flame retardant additive was used.

The flame retardants tested and the categories in which they fall are as follows:
i) Bis(allyl ether) of tetrabromobisphenol-S (FR-1);
ii) Bis(2,3-dibrompropyl ether) of tetrabromobisphenol-S (FR-2);
iii) Tetrabromoxylenes (FR-3);
iv) Tribromoneopentyl alcohol (FR-4);
v) Tris(dibrompropyl) 1,2,4-benzenetricarboxylate (FR-5);
vi) Brominated phenyl terminated partially hydrogenated polybutadiene (FR-6).

For convenience, these specific flame retardants are identified in Table 3 by the category in which they fall. Table 3 thus identifies the compositions and summarizes the results of this group of Examples.

TABLE 3

| | | | | Particle size distribution of beads, % | | | | | |
|---|---|---|---|---|---|---|---|---|---|
| | Flame | | | | 2 mm | 1.4 mm | 1 mm | 710 μm | 500 μm |
| Ex | retardant | Cat. | Loading | >2 mm | to >1.4 mm | to >1 mm | to >710 μm | to >500 μm | to >250 μm |
| 28 | FR-1 | i) | 1.06 wt % | 7.58 | 14.73 | 60.97 | 13.84 | 2.06 | 0.82 |
| 29 | FR-2 | ii) | 0.8 wt % | 4.45 | 26.30 | 57.94 | 9.43 | 1.09 | 0.80 |
| 30 | FR-3 | iii) | 0.7 wt % | 4.47 | 9.90 | 61.40 | 20.13 | 3.40 | 0.70 |
| 31 | FR-4 | iv) | 0.7 wt % | 4.10 | 20.17 | 56.35 | 15.44 | 2.55 | 1.39 |
| 32 | FR-5 | v) | 1.78 wt % | 2.70 | 20.27 | 61.75 | 10.33 | 2.90 | 2.05 |
| 33 | FR-6 | vi) | 0.82 wt % | 2.86 | 15.10 | 52.16 | 22.86 | 5.07 | 1.95 |
| CB | None | — | 0 | 9.64 | 50.65 | 33.9 | 3.67 | 0.86 | 1.28 |

### EXAMPLES 34-37

Examples 34-37 illustrate the syntheses of tris(dibromoalkyl) benzenetricarboxylates in which each dibromoalkyl group contains, independently, 3 to 8 carbon atoms, brominated aryl-terminated partially hydrogenated polybutadienes, and brominated 1,2-polybutadienes, i.e., flame retardants of categories v) and vi).

### EXAMPLE 34

Triallyl 1,2,4-benzenetricarboxylate (201 g, 0.609 mol) was added to dichloromethane (˜1 kg) in a flask in a circulating bath. Bromine (292 g, 1.83 mol) was added dropwise over 30 minutes to the triallyl benzenetricarboxylate solution, with stirring. The circulating bath temperature was 3 to 6° C., and the reaction temperature ranged from 15 to 25° C. during the bromine addition. After the bromine addition was finished, the reaction mixture was heated to 35° C. for 30 minutes while stirring. Excess bromine was quenched by addition of aqueous sodium sulfite to the reaction mixture, and the reaction mixture was then neutralized by adding aqueous sodium carbonate (10 wt %; to pH ˜10-12). Two layers formed, and the dichloromethane layer was separated from the aqueous layer. The solvent was removed from the separated dichloromethane layer under vacuum. The tris(2,3-dibromopropyl) 1,2,4-benzenetricarboxylate product was a clear, viscous liquid, and contained 59.2 wt % bromine.

### EXAMPLE 35

Triallyl 1,3,5-benzenetricarboxylate (5 g, 0.015 mol) was added to dichloromethane (˜25 g) in a flask in a circulating bath. Bromine (7.3 g, 0.045 mol) was added dropwise to the triallyl benzenetricarboxylate solution, with stirring. The circulating bath temperature was 3-6° C., and the reaction temperature ranged from 10 to 25° C. during the bromine addition. After the bromine addition was finished, the reaction was heated to 35° C. for 30 minutes while stirring. Excess bromine was quenched by addition of aqueous sodium sulfite to the reaction mixture, and the reaction mixture was then neutralized by adding aqueous sodium carbonate (10 wt %; to pH ˜10-12). Two layers formed, and the dichloromethane layer was separated from the aqueous layer. The solvent was removed from the separated dichloromethane layer under vacuum. The tris(2,3-dibromopropyl) 1,3,5-benzenetricarboxylate product was a clear, viscous liquid. After several months, the product had partially solidified.

### EXAMPLE 36

Phenyl-terminated partially hydrogenated polybutadiene (35 g; 0.388 mol unsaturated butylene units, density=0.930; 60 wt % unsaturation: 45 wt % vinyl, 10 wt % trans-1,4, 5% cis-1,4, 0.250 mol saturated butyl units and ˜0.019 mol of phenyl units; Mₙ ˜1,800, Aldrich Chemical Company) was added to dichloromethane (1 kg) and methanol (115 g) in a flask in a circulating bath. The circulating bath temperature was set at 20° C. for the vapor addition of bromine. A separate flask containing bromine and equipped with a gas sparger was heated to 58-60° C. The bromine was fed into the polybutadiene mixture via the sparger with nitrogen as the carrier gas while stirring the polybutadiene mixture. One hour after the initiation of the bromine feed, 1 mL aqueous HBr (48 wt %) was added to the reaction flask, and the reaction temperature was increased to 30° C. After 1.5 hours total feeding time, another 2 mL aqueous HBr (48 wt %) were added. After 3 hours total feeding time, another 2 mL HBr (aq., 48 wt %) were added, and the reaction temperature was increased to 33° C. Feeding of bromine was stopped after 4 hours total bromine feeding time. The progress of the bromination reaction was monitored by ¹H NMR (of the unsaturated groups). The bromination reaction was quenched by adding aqueous sodium sulfite to the reaction mixture. Aqueous sodium carbonate was then added to the reaction mixture to neutralize the aqueous solution (to pH ˜9). Two layers formed, and the dichloromethane layer was separated from the aqueous layer, concentrated under vacuum, and then added dropwise to methanol to precipitate the brominated polybutadiene. The yield of brominated phenyl-terminated polybutadiene after drying at room temperature under vacuum for 48 hours was 99 g (theoretical is 97 g), and the product had 64.4 wt % bromine (theoretical is 63.9 wt % bromine). Some of the properties of the product are listed in Table 4.

### EXAMPLE 37

Brominated phenyl-terminated partially hydrogenated polybutadiene was made as described in Example 36, except that 51 g (0.57 mol unsaturated butenyl units, 0.36 mol saturated butyl units and 0.03 mol of phenyl units) of phenyl-terminated polybutadiene were used, 3 mL aqueous HBr (48 wt %) was present initially in the reaction flask prior to the initiation of the bromine feed, and the neutralization was carried out with sodium hydroxide. The product contained 66.8 wt % bromine (theoretical is 63.9 wt % bromine). Some of the properties of the product are listed in Table 4.

TABLE 4

| | | Measured | Theoretical | Solubility in | | TGA 5 | TGA 50 |
|---|---|---|---|---|---|---|---|
| Ex. | Mₙ | bromine content | bromine content | styrene | T_{g} | wt % loss | wt % loss |
| 36¹ | ~1800 | 64.4 wt % | 63.9 wt % | >40 wt % | 88° C. | 201° C. | 249° C. |
| 37¹ | ~1800 | 66.8 wt % | 63.9 wt % | >40 wt % | 93° C. | 210° C. | 268° C. |

¹Brominated phenyl-terminated partially hydrogenated polybutadiene, category vi).

Example 38 illustrates the synthesis of a mixture of tetrabromoxylene isomers, which fall into flame retardant category iii).

### EXAMPLE 38

The xylenes used in this preparation contained about 14% ethylbenzene. A 5-L, three-necked round-bottom flask was equipped with a mechanical stirrer, a thermometer with a Therm-o-Watch®, a glycol-cooled (0° C.) reflux condenser, an addition funnel and an ice-cold caustic scrubber. The flask was charged first with bromine (3196 g, 1031 mL, 20 mol), followed by dibromomethane (1500 mL), and then iron powder (6 g, 325 mesh). The slurry was mechanically stirred at ambient temperature. The addition funnel was charged with xylenes. The xylenes were added to the stirring slurry over a period of 2.25 hours. The reaction appeared to be instantaneous, and the reaction temperature rose from 30° C. to 48° C. during the addition. After the addition was over, the reaction mixture was heated to reflux at 83° C. for additional 20 minutes. The reflux temperature rose to 91° C. during this period. The reaction slurry was cooled to 25° C., and water (1500 mL) was charged to the reactor in order to decompose the catalyst and steam distill excess bromine and solvent. The addition of water was exothermic and, as a result, the temperature of the slurry rose to 45° C.

The equipment was set for distillation and the slurry was heated in order to distill bromine and dibromomethane. Distillation began at 77° C. The bromine/dibromomethane distillate was collected while the aqueous phase was continuously returned to the reactor. A total of about 1200 mL of distillate was collected over two hours. The contents of the distillation pot were cooled to ambient temperature, and the slurry was filtered using a coarse sintered glass funnel. At this point, a significant amount of bromine still remained dissolved in the solvent and water. The distillation was stopped because the product and the remaining solvent were a relatively homogeneous mass (a lump), probably due to a strong affinity of the product for the solvent. This lump put a severe strain on the agitator.

The crystalline solid on the filter frit was washed with water (2×500 mL) and then allowed to dry overnight in air and then at 92° C. in a forced-air oven for 1.5 hours to give a light reddish solid, weighing 1418.5 grams (Crop A). The filtrate was concentrated on a rotary evaporator to approximately half the original volume and was then allowed to cool to room temperature. This resulted in the precipitation of more solids (Crop B) which were isolated by filtration and then dried in air to give 190 g of a tan, powdery solid. Crop A and Crop B were combined and washed with acetone (2×2 L), which removed most of the color. Evaporation of the acetone from the washings resulted in the separation of an almost-black solid, weighing 49.3 grams. Gas chromatography mass spectrometry (GC-MS) analysis indicated this material to be predominantly pentabromoethylbenzene (84.5 area %), with tetrabromoxylenes (12.1 area %) and tetrabromo(methyl)benzyl bromide (3.0 area %) as minor components.

The washed cake was dried in air for 3 hours and then in an oven at 92° C. for one hour to give an off-white solid weighing 1524 grams, which is 3.6 moles of tetrabromoxylenes, a 90% yield. The melting point of the tetrabromoxylenes was 220-230° C. GC-MS was performed on the product, and showed the following composition:

| | |
|---|---|
| Tetrabromoxylenes (three isomers): | 93.5 area % |
| Pentabromoethylbenzene: | 6.5 area % |

Example 39 illustrates the synthesis of brominated phenyl-terminated poly(1,3-cyclohexadiene), a flame retardant of category viii).

### EXAMPLE 39

Phenyl-terminated poly(1,3-cyclohexadiene) was prepared in a manner similar to the method described in Macromolecules, 1998, 31, 4687, coupled with polymerization termination by bromobenzene. The polymerization inhibitor was removed from the cyclohexane solvent by passing the cyclohexane through a short silica gel column. The glassware was oven-dried and purged with nitrogen prior to use in the polymerization. Cyclohexane, 1,3-cyclohexadiene, and bromobenzene were purged with nitrogen for about 30 minutes prior to use in the polymerization. Cyclohexane (20 mL) was added via a cannula to a fluid circulating jacketed four-necked round bottom flask equipped with a mechanical overhead stirrer, thermocouple, rubber septum, and nitrogen atmosphere. Initiators N,N,N′,N′-tetramethylethylenediamine (TMEDA; 1.6 mL, 0.010 mol, 1.25 eq) and n-BuLi (4.1 mL, 0.0083 mol) were added and the mixture was stirred at 50° C. for about 10 minutes. The remainder of the cyclohexane (200 mL) was then added. The de-inhibited 1,3-cyclohexadiene (25.2 g, 0.314 mol) was added rapidly to the mixture and the resultant mixture was stirred at 50° C. for about 2 hours. Nitrogen-purged bromobenzene (6.5 g, 0.042 mol) was then added to terminate the polymer with phenyl groups. The polymer was precipitated by the addition of isopropanol. The precipitated polymer (phenyl-terminated poly(1,3-cyclohexadiene)) was filtered and rinsed with water, isopropanol, and methanol. The resulting polymer (26 g of Mₙ ˜3,000) was dried at room temperature overnight under reduced pressure.

The dry phenyl-terminated poly(1,3-cyclohexadiene) (23.2 g, 0.278 mol reactive repeat units) was added to about 1 kg of bromochloromethane and 56 g methanol in a fluid circulating jacketed four-necked round bottom flask equipped with a mechanical overhead stirrer, thermocouple, and nitrogen atmosphere. Ambient light in the flask was minimized. The reaction temperature ranged from 5 to 50° C. during the dropwise addition of bromine (14.3 mL, 44.6 g, 0.279 mol). About 2 mL of aqueous HBr was added during the bromine addition (after about 11 mL bromine was added). The progress of the bromination reaction was monitored by ¹H NMR (of the unsaturated groups). The bromination reaction was quenched by treating the reaction mixture with an aqueous solution containing 400 g water, 2 g sodium sulfite, and 7 g sodium carbonate to the reaction mixture until the mixture was basic (pH ˜9). Two layers formed, and the bromochloromethane layer was separated from the aqueous layer and the bromochloromethane layer was concentrated under vacuum. The brominated polymer was dissolved in tetrahydrofuran and added dropwise to methanol to precipitate the brominated phenyl-terminated polybutadiene. After drying at room temperature under vacuum for 48 hours, 43.6 g of polymer containing 52.0 wt % (theoretical: 65.7 wt %) bromine was obtained.

### EXAMPLES 40-42

Examples 40-42 illustrate the syntheses of brominated N,N′-1,3-phenylenebismaleimide, brominated N,N′-(4,4′-methylenediphenyl)bismaleimide, and N,N′-ethylenebismaleimide, i.e., flame retardants of categories x), xi), and xii).

### EXAMPLE 40

Conditions for this synthesis have not been optimized. Chloroform (˜700 g) was placed in a fluid circulating jacketed four-necked round bottom flask equipped with a mechanical overhead stirrer and thermocouple. 1,3-Phenylenedimaleimide,(20.2 g, 0.075 mol) was added to the chloroform. Bromine (24.1 g, 0.151 mol) was added dropwise over ˜30 minutes to the dimaleimide solution, with stirring at 50-55° C. The reaction was then stirred at 55° C. overnight. A white precipitate had formed, and the reaction was cooled. The precipitate was filtered, then slurried and rinsed with aqueous sodium bicarbonate, and then washed with water and methanol. The solid was dried at 120° C. in an oven under reduced pressure to yield 20 g, a 45% yield of N,N′-1,3-phenylenebismaleimide. The brominated product was a solid yellow powder, containing 53.1 wt % bromine (theoretical: 54.4 wt %).

### EXAMPLE 41

Dichloromethane (2.4 kg) was placed in a fluid circulating jacketed four-necked round bottom flask equipped with a mechanical overhead stirrer and thermocouple. N,N′-(4,4′-methylenediphenylene)bismaleimide (502 g, 1.40 mol) was added to the dichloromethane. Bromine (479 g, 2.82 mol) was added dropwise over 60 minutes to the bismaleimide solution, with stirring. The initial circulating bath temperature was 43° C. After about 35 mL bromine had been added, an exothermic precipitation commenced. The bromine addition rate was slowed, and the bath temperature was reduced to 30° C. to control the reaction temperature (<41° C.). After the bromine addition was -completed, the reaction mixture was heated at 43° C. overnight. The volume of dichloromethane and residual bromine were reduced by distillation into a basic scrubber (10 wt % sodium carbonate, 10 wt % sodium sulfite). Methanol (˜1 kg) was added to slurry the precipitated solid, the slurry was filtered, and the precipitate was rinsed three times with methanol and dried in an oven under reduced pressure to yield 843 g of N,N′-(4,4′-methylenediphenylene)bismaleimide, an 89% yield. The brominated product was a solid off-white powder, containing about 47.1 wt % bromine.

### EXAMPLE 42

Dichloromethane (˜100 g) was placed in a fluid circulating jacketed four-necked round bottom flask equipped with a mechanical overhead stirrer and thermocouple. Ethylenediamine bismaleimide (22.9 g, 0.104 mol) was added to the dichloromethane. Bromine (33.2 g, 0.208 mol) was added dropwise over 30 minutes to the bismaleimide solution, with stirring at reflux. A precipitate began forming after about 3.5 hours, and the reaction mixture was stirred overnight. The volume of dichloromethane and residual bromine were reduced by distillation into a basic scrubber (10 wt % sodium carbonate, 10 wt % sodium sulfite). Methanol (˜100 g) was added to slurry the precipitated solid, the slurry was filtered, and the precipitate was rinsed with methanol and water and dried at 100° C. in an oven under reduced pressure to yield 39 g of brominated N,N′-ethylenebismaleimde, a 69.5% yield. The brominated product was a solid off-white powder, containing about 59.2 wt % bromine.

Example 43 illustrates the synthesis of a brominated allyl ether of a novolac, i.e., a flame retardant of category vii). In Example 43, all equivalents (equiv) are relative to the novolac.

### EXAMPLE 43 9016-27 (XP-7203)

Allyl alcohol (138 g,2.4 mol, 10 equiv), dimethylcarbonate (214 g, 2.4 mol, 10 equiv), and a catalytic amount of sodium methoxide (0.4 g, 7.1 mmol, 0.03 equiv) were added to a 500 mL fluid circulating jacketed four-necked round bottom flask, equipped with a mechanical overhead stirrer, thermocouple, and nitrogen atmosphere and stirred for 30 minutes at 24° C. Phenol-formaldehyde novolac (25 g, 0.24 mol, M, 1135 g/mol, 105 g/equiv hydroxyl, DURITE® SD-1731, Borden Chemical, Inc., Louisville, Ky.) was added to the reaction mixture, along with a catalytic amount of triphenylphosphine (0.1 g, 0.4 mmol, 0.15 equiv) and 5% palladium on carbon (0.3 g). The reaction was heated to about 81° C. (circulating bath heated to 87° C.). The progress of the reaction was monitored by ¹H NMR spectroscopy and was complete after about 5 hours. The reaction mixture was washed with aqueous sodium carbonate, followed by filtering the organic phase through Celite®. The solvent was removed, and the product novolac allyl ether was dried at about 40° C. under vacuum for about 24 hours.

About 30 g (0.11 mol) of the novolac allyl ether were added to about 1 kg of dichloromethane and methanol (62 g, 5.5 wt %) in a 2 L fluid circulating jacketed five-necked round bottom flask equipped with a mechanical overhead stirrer, thermocouple, and nitrogen atmosphere. Bromine (34 g, 0.22 mol, 2 equiv) was added dropwise to the solution at 15° C. under a nitrogen atmosphere over about 15 minutes. The reaction mixture was warmed to 28° C. over 1 hour. About 11 mL of aqueous HBr (48 wt %) was added gradually to the reaction mixture over 3 hours. The reaction was monitored by ¹H NMR spectroscopy and was complete after 3.25 hours. The reaction mixture was washed with aqueous sodium carbonate and aqueous sodium sulfite. The dichloromethane layer was separated, the solvent volume of the dichloromethane solution was reduced, and the brominated product was precipitated by dropwise addition of the dichloromethane solution to methanol such that a dilute solution of dichloromethane (about 10 wt %) in methanol was formed. After drying the precipitated product at room temperature under vacuum for 48 hours, a brominated allyl ether of phenol-formaldehyde novolac containing 51.1 wt % bromine (theoretical: 53.0 wt %) was obtained.

It is to be understood that the reactants and components referred to by chemical name or formula anywhere in this document, whether referred to in the singular or plural, are identified as they exist prior to coming into contact with another substance referred to by chemical name or chemical type (e.g., another reactant, a solvent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical operation or reaction or in forming a mixture to be used in conducting a desired operation or reaction. Also, even though an embodiment may refer to substances, components and/or ingredients in the present tense (“is comprised of”, “comprises”, “is”, etc.), the reference is to the substance, component or ingredient as it existed at the time just before it was first contacted, blended or mixed with one or more other substances, components and/or ingredients in accordance with the present disclosure.

Also, even though the claims may refer to substances in the present tense (e.g., “comprises”, “is”, etc.), the reference is to the substance as it exists at the time just before it is first contacted, blended or mixed with one or more other substances in accordance with the present disclosure. Each and every patent or publication referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, the description or a to a single element to which the article refers. Rather, the article “a” or “an” if and as used herein is intended to cover one or more such elements, unless the text expressly indicates otherwise.

This invention is susceptible to considerable variation within the spirit and scope of the appended claims. Therefore the foregoing description is not intended to limit, and should not be construed as limiting, the invention to the particular exemplifications presented hereinabove.

1. A flame retardant styrenic polymer foam composition which comprises a styrenic polymer and flame retardant amount of flame retardant resulting from inclusion in the foam recipe before or during formation of the foam:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated aryl-terminated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis (dibromonorbornane-dicarboximide); or
xiv) tetrabromobisphenol-A; or
xv) a combination of any two or more of i) through xiv).

2. A flame retardant styrenic polymer foam composition as in claim 1 wherein said styrenic polymer foam composition is either a) in the form of expandable styrenic polymer beads or granules or b) in the form of an extruded styrenic polymer foam; when said styrenic polymer foam composition is a), said flame retardant is
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or a combination of any two or more of i) through vii);
and when said styrenic polymer foam composition is b), said flame retardant is
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis (dibromonorbornane-dicarboximide); or
xiv) tetrabromobisphenol-A; or
a combination of any two or more of ii) through xiv).

3. A composition as in claim 2 wherein no other flame retardant is employed.

4. A composition as in claim 3 wherein said styrenic polymer foam composition is in the form of
expandable styrenic polymer beads or granules, and wherein at least one synergist or
at least one thermal stabilizer is included in said composition, or
an extruded styrenic polymer foam, and wherein at least one synergist or at least one thermal stabilizer is included in said composition.

5. (canceled)

6. A composition as in claim 1 wherein said flame retardant is at least one diether of tetrabromobisphenol-S, wherein the ether groups do not contain bromine, wherein at least one of the ether groups is an allyl group, and wherein said diether of tetrabromobisphenol-S is the bis(allyl ether) of tetrabromobisphenol-S.

7. A composition as in claim 1 wherein said flame retardant is at least one diether of tetrabromobisphenol-S, wherein at least one of the ether groups contains bromine, and wherein said diether of tetrabromobisphenol-S is the bis(2,3-dibrompropyl ether) of tetrabromobisphenol-S.

8. A composition as in claim 1 wherein said flame retardant is at least one substituted benzene having a total of 6 substituents on the ring wherein at least 3 of the substituents are bromine atoms and at least two of the substituents are C₁₋₄ alkyl groups, and is at least one tetrabromoxylene.

9. (canceled)

10. A composition as in claim 1 wherein said flame retardant is at least one tris(dibromoalkyl) benzenetricarboxylate in which each dibromoalkyl group contains, independently, 3 to 8 carbon atoms, and wherein said tris(dibromoalkyl) benzenetricarboxylate is tris(2,3-dibrompropyl) 1,2,4-benzenetricarboxylate or tris(2,3-dibrompropyl) 1,3,5-benzenetricarboxylate.

11. A composition as in claim 1 wherein said flame retardant is at least one brominated aryl-terminated partially hydrogenated polybutadiene.

12. (canceled)

13. A composition as in claim 1 wherein said flame retardant is at least one brominated poly(1,3-cycloalkadiene), and wherein said brominated poly(1,3-cycloalkadiene) is at least one brominated poly(1,3-cyclohexadiene) or at least one brominated aryl-terminated poly(1,3-cyclohexadiene).

14-19. (canceled)

20. A composition as in claim 2 wherein said styrenic polymer foam composition is in the form of expandable styrenic polymer beads or granules and wherein the styrenic polymer of said expandable styrenic beads or granules is composed of an average of at least 80 wt % of polymerized styrene.

21. (canceled)

22. A composition as in claim 2 wherein said styrenic polymer foam composition is in the form of an extruded styrenic polymer foam and wherein said extruded styrenic polymer foam is composed of at least 80 wt % of polymerized styrene.

23. (canceled)

24. A composition as in claim 1 wherein said styrenic polymer is crystal polystyrene.

25. A composition as in claim 4 wherein a synergist is included, and wherein said synergist is dicumyl.

26. A composition as in claim 25 wherein said flame retardant is at least one substituted benzene having a total of 6 substituents on the ring and wherein at least 3 of the substituents are bromine atoms and at least two of the substituents are C₁₋₄ alkyl groups, and is at least one tetrabromoxylene.

27-28. (canceled)

29. A composition as in claim 4 wherein said styrenic polymer foam composition is in the form of an extruded styrenic polymer foam, and wherein said flame retardant is tetrabromobisphenol-A.

30. A composition as in claim 4 wherein a thermal stabilizer is included, and wherein said thermal stabilizer is dibutyl tin maleate or hydrocalcite.

31. A composition as in claim 30 wherein said thermal stabilizer is dibutyl tin maleate, and said flame retardant is at least one brominated aryl-terminated partially hydrogenated polybutadiene, or either at least one brominated aryl-terminated partially hydrogenated polybutadiene or at least one brominated aryl-terminated poly(1,3-cycloalkadiene).

32-33. (canceled)

34. A method of preparing a flame retardant styrenic polymer foam composition as in claim 1, said method comprising including in the foam recipe of said composition before or during formation of the foam:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis (dibromonorbornane-dicarboximide); or
xiv) tetrabromobisphenol-A; or
xv) a combination of any two or more of i) through xiv).

35. A method of preparing expandable styrenic beads or granules from a suspension-polymerizable mixture comprised of at least one styrenic monomer, said method characterized by including in said mixture a flame retardant amount of flame retardant of claim 34.

36. A method as in claim 35 wherein said at least one styrenic monomer is a mixture of styrenic monomers, at least 80 wt % of said monomers being styrene.

37. (canceled)

38. A method of preparing larger expanded beads or granules of at least one styrenic polymer, which method comprises expanding smaller beads or granules formed from a suspension polymerization recipe in which was included at least one flame retardant of claim 34.

39. A method as in claim 38 wherein said smaller styrenic beads or granules and said larger styrenic beads or granules are composed of at least 80 wt % of styrene.

40. (canceled)

41. A method of preparing a styrenic polymer foam, which method comprises molding expanded beads or granules of at least one styrenic polymer formed from a recipe in which was included at least one flame retardant of claim 34.

42. A method as in claim 41 wherein said at least one styrenic polymer is composed of at least 80 wt % of styrene.

43. (canceled)

44. A method of preparing an extruded styrenic foam from a foamable molten styrenic polymer mixture, said method characterized by including in said mixture a flame retardant amount of flame retardant of claim 34.

45. A method as in claim 44 wherein said styrenic polymer is composed of at least 80 wt % of polymerized styrene.

46. A method as in claim 44 wherein said styrenic polymer is crystal polystyrene.

47. A flame retardant styrenic polymer foam recipe in which was included a flame retardant amount of flame retardant, said flame retardant at least prior to inclusion being:
i) at least one diether of tetrabromobisphenol-S, wherein the ether groups do not contain bromine and wherein at least one of the ether groups is an allyl group; or
ii) at least one diether of tetrabromobisphenol-S, wherein at least one of the ether groups contains bromine; or
iii) at least one substituted benzene having a total of 6 substituents on the ring and wherein at least 3 of the substituents are bromine atoms and at least two of the substituents are C₁₋₄ alkyl groups; or
iv) tribromoneopentyl alcohol; or
v) at least one tris(dibromoalkyl) benzenetricarboxylate in which each dibromoalkyl group contains, independently, 3 to 8 carbon atoms; or
vi) at least one brominated polybutadiene which is partially hydrogenated, aryl-terminated, or both partially hydrogenated and aryl-terminated; or
vii) at least one brominated allyl ether of a novolac; or
viii) at least one brominated poly(1,3-cycloalkadiene); or
ix) at least one brominated poly(4-vinylphenol allyl ether); or
x) at least one brominated N,N′-phenylenebismaleimide; or
xi) at least one brominated N,N′-(4,4′-methylenediphenyl)bismaleimide; or
xii) at least one brominated N,N′-ethylenebismaleimide; or
xiii) ethylenebis (dibromonorbornane-dicarboximide); or
xiv) tetrabromobisphenol-A; or
xv) a combination of any two or more of i) through xiv).

48. A styrenic polymer foam recipe as in 47 wherein said flame retardant at least prior to inclusion in said recipe is at least one diether of tetrabromobisphenol-S, wherein the ether groups do not contain bromine, wherein at least one of the ether groups is an allyl group, and wherein said diether of tetrabromobisphenol-S is the bis(allyl ether) of tetrabromobisphenol-S.

49. A styrenic polymer foam recipe as in 47 wherein said flame retardant at least prior to inclusion in said recipe is at least one diether of tetrabromobisphenol-S, wherein at least one of the ether groups contains bromine, and wherein said diether of tetrabromobisphenol-S is the bis(2,3-dibromopropyl ether) of tetrabromobisphenol-S.

50. A styrenic polymer foam recipe as in 47 wherein said flame retardant at least prior to inclusion in said recipe is at least one substituted benzene having a total of 6 substituents on the ring wherein at least 3 of the substituents are bromine atoms and at least two of the substituents are C1-4 alkyl groups, and is at least one tetrabromoxylene.

51. (canceled)

52. A styrenic polymer foam recipe as in 47 wherein said flame retardant at least prior to inclusion in said recipe is at least one tris(dibromoalkyl) benzenetricarboxylate in which each dibromoalkyl group contains, independently, 3 to 8 carbon atoms, and wherein said tris(dibromoalkyl) benzenetricarboxylate is tris(2,3-dibrompropyl) 1,2,4-benzenetricarboxylate or tris(2,3-dibrompropyl) 1,3,5-benzenetricarboxylate.

53. A styrenic polymer foam recipe as in 47 wherein said flame retardant at least prior to inclusion in said recipe is at least one brominated aryl-terminated partially hydrogenated polybutadiene.

54. (canceled)

55. A styrenic polymer foam recipe as in 47 wherein said flame retardant at least prior to inclusion in said recipe is at least one brominated poly(1,3-cycloalkadiene), and wherein said brominated poly(1,3-cycloalkadiene) is at least one brominated poly(1,3-cyclohexadiene) or at least one brominated aryl-terminated poly(1,3-cyclohexadiene).

56-61. (canceled)

62. A composition of matter which comprises at least one of the following:
a) a brominated partially hydrogenated polybutadiene;
b) a brominated aryl-terminated polybutadiene;
c) a brominated aryl-terminated partially hydrogenated polybutadiene;
d) a brominated allyl ether of a novolac;
e) a brominated poly(1,3-cycloalkadiene);
f) a brominated aryl-terminated poly(1,3-cyclohexadiene);
g) a brominated N,N′-phenylenebismaleimide;
h) a brominated N,N′- 1,3-phenylenebismaleimide;
i) a brominated N,N′-(4,4′-methylenediphenyl)bismaleimide; or
j) a brominated N,N′-ethylenebismaleimide.

63. A process for preparing a composition of matter as in claim 62, which process comprises contacting, in a liquid medium, bromine and
c) at least one aryl-terminated partially hydrogenated polybutadiene, to form a brominated aryl-terminated partially hydrogenated polybutadiene;
d) at least one allyl ether of a novolac, to form a brominated allyl ether of a novolac;
e) at least one poly(1,3-cycloalkadiene), to form a brominated poly(1,3-cycloalkadiene);
g) at least one N,N′-phenylenebismaleimide, to form a brominated N,N′-phenylenebismaleimide;
i) N,N′-(4,4′-methylenediphenyl)bismaleimide, to form a brominated N,N′-(4,4′-methylenediphenyl)bismaleimide; or
j) N,N′-ethylenebismaleimide, to form a brominated N,N′-ethylenebismaleimide.

64-68. (canceled)
